(19) United States
(12) Patent Application Publication
(10) Pub. No.: US 2020/0410495 A1
(43) Pub. Date: Dec. 31, 2020

(54) ADJUSTABLE ELECTRONIC SETTLEMENT BASED ON RISK

(71) Applicant: Srinivas Tadiparti, Bothell, WA (US)

(72) Inventor: Srinivas Tadiparti, Bothell, WA (US)

(21) Appl. No.: 16/451,324

(22) Filed: Jun. 25, 2019

(51) Int. Cl. G06Q 20/40; G06Q 20/38; G06Q 20/02

(52) U.S. Cl. CPC G06Q 20/4016; G06Q 20/023; G06Q 20/388

(57) ABSTRACT

The system may be able to promptly determine a fraud score. Based on the fraud score which may be determined in virtually real time by communicating the transaction data to the system, a percentage of the transaction may be made immediately be available to a merchants.

### BACKGROUND

At a high level, merchants often have to wait a period of time to receive funds for their transactions. The typical four party model may withhold funds for a period of time which may be a plurality of days such that if there is a decline of the transaction or fraud, the funds may be withheld until the decline of the transaction is addressed or the fraud investigated. For transactions that are not problematic, it may be helpful for merchants to have funds sooner. However, the traditional four party model adds delays to reduce risk to the parties to the transaction.

There are many technical problems to speed up the transactions and the disbursements of funds to merchants. At a high level, each party to the transaction will want to analyze the transaction for fraud and risk. Each of those parties have their own algorithms and issues they want to review which adds time to the process.

### SUMMARY OF THE INVENTION

To address these technical problems, the transaction may be compared in almost real time to a fraud database. The fraud database may have a significant amount of data and very sophisticated fraud detection algorithms. The system may be able to promptly determine a fraud score. Based on the fraud score which may be determined in virtually real time by communicating the transaction data to the system, a percentage of the transaction may be made immediately be available to a merchants.

### BRIEF DESCRIPTION OF THE DRAWINGS

FIG. 1 may be an illustration of a sample payment network;

FIG. 2 may be a flowchart of a payment method for merchants;

FIG. 3 may be a user interface presented to a merchant;

FIG. 4 may be a user interface presented to a merchant;

FIG. 5 may be an illustration of training data and testing data;

FIG. 6a may be an illustration of training data and testing data;

FIG. 6b may be an illustration of training data and testing data; and

FIG. 7 may be a detailed view of the elements of a computer used in the system.

### SPECIFICATION

The present system, method and tangible memory device now will be described more fully with reference to the accompanying drawings, which form a part hereof, and which show, by way of illustration, specific exemplary embodiments by which the system, method and tangible memory device may be practiced. These illustrations and exemplary embodiments are presented with the understanding that the present disclosure is an exemplification of the principles of one or more system, method and tangible memory devices and is not intended to limit any one of the system, method and tangible memory devices to the embodiments illustrated. The system, method and tangible memory device may be embodied in many different forms and should not be construed as limited to the embodiments set forth herein; rather, these embodiments are provided so that this disclosure will be thorough and complete, and will fully convey the scope of the system, method and tangible memory device to those skilled in the art. Among other things, the present system, method and tangible memory device may be embodied as methods, systems, computer readable media, apparatuses, components, or devices. Accordingly, the present system, method and tangible memory device may take the form of an entirely hardware embodiment, an entirely software embodiment, or an embodiment combining software and hardware aspects. The hardware may be local, may be remote or may be a combination of local and remote. The following detailed description is, therefore, not to be taken in a limiting sense.

At a high level, merchants often have to wait a period of time to receive funds for their transactions. The typical four part model may withhold funds for a period of time which may be a plurality of days such that if there is a decline of the transaction or fraud, the funds may be withheld until the decline of the transaction is addressed or the fraud investigated. For transactions that are not problematic, it may be helpful for merchants to have funds sooner. However, the traditional four party model adds delays to reduce risk to the parties to the transaction. In addition, the delayed transaction settlement causes more network traffic, memory usage and processor cycles as the transaction has to be processed more or less twice, once when it first occurs and again when settlement occurs.

There are many technical problems to speed up the transactions and the disbursements of funds to merchants. At a high level, each party to the transaction will want to analyze the transaction for fraud and risk. Each of those parties have their own algorithms and issues they want to review which adds time to the process. To address these technical problems, the transaction may be compared in almost real time to a fraud database. The fraud database may have a significant amount of data and very sophisticated fraud detection algorithms and may be able to promptly determine a fraud score. Based on the fraud score which may be determined in virtually real time by communicating the transaction data to a fraud API, a percentage of the transaction may be made immediately be available to a merchants.

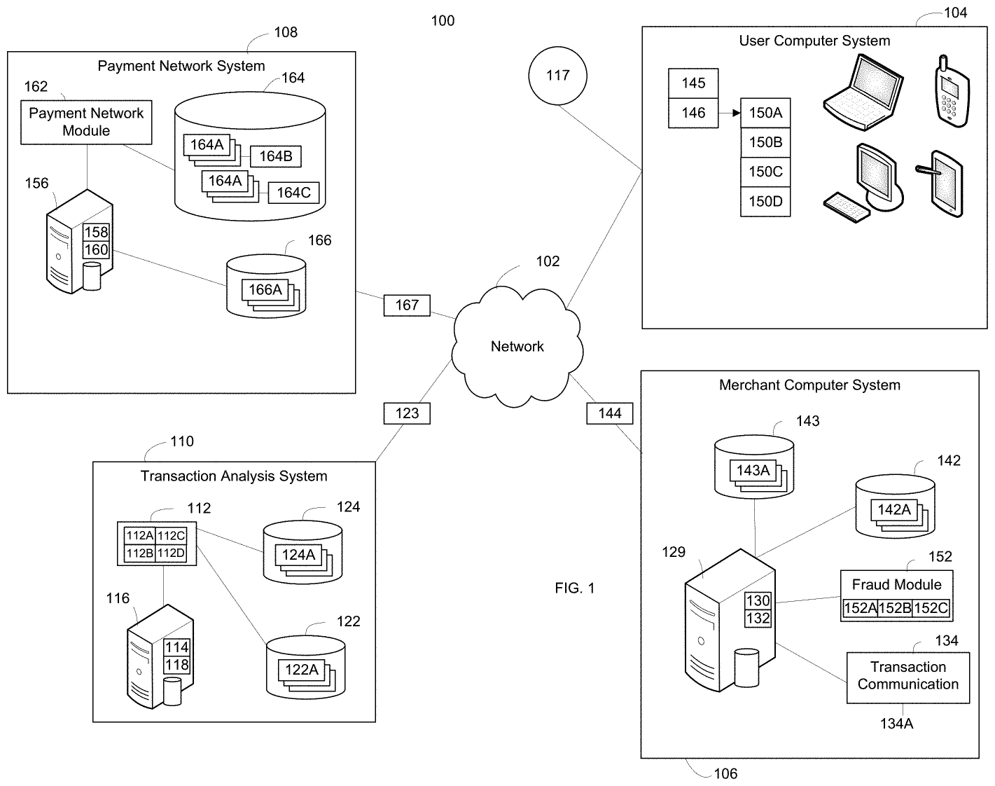

Referring to FIG. 1 which generally illustrates one embodiment of a private network such as a payment system used by the merchant 106. The system 100 may include a computer network 102 that links one or more systems and computer components. In some embodiments, the system 100 includes a user computer system 104, a merchant computer system 106, a payment network system 108, and a transaction analysis system 110 which may embody artificial intelligence.

The network 102 may be described variously as a communication link, computer network, internet connection, etc. The system 100 may include various software or computer-executable instructions or components stored on tangible memories and specialized hardware components or modules that employ the software and instructions to identify related transaction nodes for a plurality of transactions by monitoring transaction communications between users and merchants.

The various modules may be implemented as computer-readable storage memories containing computer-readable instructions (i.e., software) for execution by one or more processors of the system 100 within a specialized or unique computing device. The modules may perform the various tasks, methods, blocks, sub-modules, etc., as described herein. The system 100 may also include both hardware and software applications, as well as various data communications channels for communicating data between the various specialized and unique hardware and software components.

Networks are commonly thought to comprise the interconnection and interoperation of hardware, data, and other entities. A computer network, or data network, is a digital telecommunications network which allows nodes to share resources. In computer networks, computing devices exchange data with each other using connections, i.e., data links, between nodes. Hardware networks, for example, may include clients, servers, and intermediary nodes in a graph topology. In a similar fashion, data networks may include data nodes in a graph topology where each node includes related or linked information, software methods, and other data. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications or data network.

A computer, other device, set of related data, program, or combination thereof that facilitates, processes information and requests, and/or furthers the passage of information from a source user to a destination user is commonly referred to as a “node.” Networks generally facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

A user computer system 104 may include a processor 145 and memory 146. The user computing system 104 may include a server, a mobile computing device, a smartphone, a tablet computer, a Wi-Fi-enabled device, wearable computing device or other personal computing device capable of wireless or wired communication, a thin client, or other known type of computing device. The memory 146 may include various modules including instructions that, when executed by the processor 145 control the functions of the user computer system generally and integrate the user computer system 104 into the system 100 in particular. For example, some modules may include an operating system 150A, a browser module 150B, a communication module 150C, and an electronic wallet module 150D. In some embodiments, the electronic wallet module 150D and its functions described herein may be incorporated as one or more modules of the user computer system 104. In other embodiments, the electronic wallet module 150D and its functions described herein may be incorporated as one or more sub-modules of the payment network system 108. In some embodiments, a responsible party 117 is in communication with the user computer system 104.

In some embodiments, a module of the user computer system 104 may pass user payment data to other components of the system 100 to facilitate determining a real-time transaction analysis determination. For example, one or more of the operating system 150A, a browser module 1506, a communication module 150C, and an electronic wallet module 150D may pass data to a merchant computer system 106 and/or to the payment network system 108 to facilitate a payment transaction for a good or service. Data passed from the user computer system 104 to other components of the system may include a customer name, a customer ID (e.g., a Personal Account Number or “PAN”), address, current location, and other data.

The merchant computer system 106 may include a computing device such as a merchant server 129 including a processor 130 and memory 132 including components to facilitate transactions with the user computer system 104 and/or a payment device via other entities of the system 100. In some embodiments, the memory 132 may include a transaction communication module 134. The transaction communication module 134 may include instructions to send merchant messages 134A to other entities (e.g., 104, 108, 110) of the system 100 to indicate a transaction has been initiated with the user computer system 104 and/or payment device including payment device data and other data as herein described. The merchant computer system 106 may include a merchant transaction repository 142 and instructions to store payment and other merchant transaction data 142A within the transaction repository 142A. The merchant transaction data 142A may only correspond to transactions for products with the particular merchant or group of merchants having a merchant profile (e.g., 164B, 164C) at the payment network system 108.

The merchant computer system 106 may also include a product repository 143 and instructions to store product data 143A within the product repository 143. For each product offered by the merchant computer system 106, the product data 143A may include a product name, a product UPC code, an item description, an item category, an item price, a number of units sold at a given price, a merchant ID, a merchant location, a customer location, a calendar week, a date, a historical price of the product, a merchant phone number(s) and other information related to the product. In some embodiments, the merchant computer system 106 may send merchant payment data corresponding to a payment device to the payment network system 108 or other entities of the system 100, or receive user payment data from the user computer system 104 in an electronic wallet-based or other computer-based transaction between the user computer system 104 and the merchant computer system 106.

The merchant computer system 106 may also include a fraud module 152 having instructions to facilitate determining fraudulent transactions offered by the merchant computer system 106 to the user computer system 104. Fraud may occur in many forms from using fraudulent physical cards to fraudulent account numbers to false or misleading communication signals. The fraud API 152A may include instructions to access one or more backend components (e.g., the payment network system 108, the transaction analysis system 110, etc.) and/or the local fraud module 152 to configure a fraud graphical interface 152B to dynamically present and apply the transaction analysis data 144 to products or services 143A offered by the merchant computer system 106 to the user computer system 104. A merchant historical fraud determination module 152C may include instructions to mine merchant transaction data 143A and determine a list of past fraudulent merchants to obtain historical fraud information on the merchant.

The payment network system 108 may include a payment server 156 including a processor 158 and memory 160. The memory 160 may include a payment network module 162 including instructions to facilitate payment between parties (e.g., one or more users, merchants, etc.) using the payment system 100. The module 162 may be communicably connected to an account holder data repository 164 including payment network account data 164A.

The payment network account data 164A may include any data to facilitate payment and other funds transfers between system entities (e.g., 104, 106). For example, the payment network account data 164A may include account identification data, account history data, payment device data, etc. The module 162 may also be communicably connected to a payment network system transaction repository 166 including payment network system global transaction data 166A.

The global transaction data 166A may include any data corresponding to a transaction employing the system 100 and a payment device. For example, the global transaction data 166A may include, for each transaction across a plurality of merchants, data related to a payment or other transaction using a PAN, account identification data, a product or service name, a product or service UPC code, an item or service description, an item or service category, an item or service price, a number of units sold at a given price, a merchant ID, a merchant location, a merchant phone number(s), a customer location, a calendar week, and a date, corresponding to the product data 143A for the product that was the subject of the transaction or a merchant phone number. The payment module 162 may also include instructions to send payment messages 167 to other entities and components of the system 100 in order to complete transactions between users of the user computer system 104 and merchants of the merchant computer system 106 who are both account holders within the payment network system 108.

The transaction analysis system 110 may include one or more instruction modules including a transaction analysis module 112 that, generally, may include instructions to cause a processor 114 of a transaction analysis server 116 to functionally communicate with a plurality of other computer-executable steps or sub-modules, e.g., sub-modules 112A, 112B, 112C, 112D and components of the system 100 via the network 102. These modules 112A, 112B, 112C, 112D may include instructions that, upon loading into the server memory 118 and execution by one or more computer processors 114, dynamically determine transaction analysis data for a product 143A or a mobile merchant computer system 106 using various stores of data 124A in one more databases 124 such as fraud data 122A in a fraud database 122. As an example, sub-module 112A may be dedicated to dynamically determine transaction analysis data based on transaction data associated with a merchant 106.

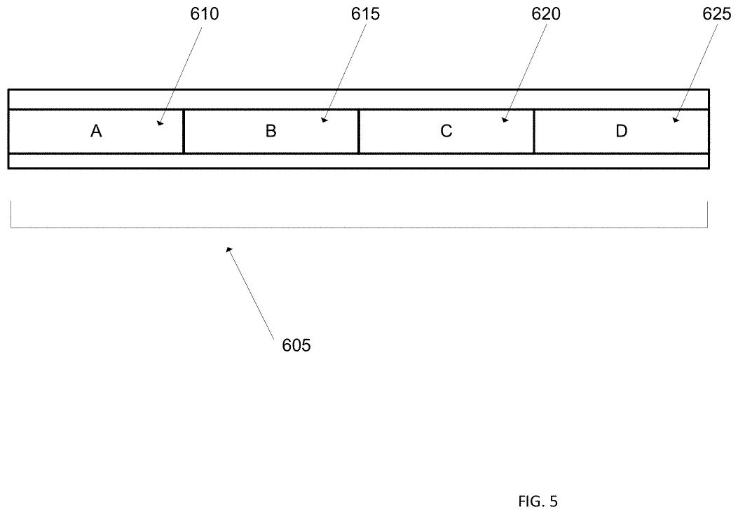

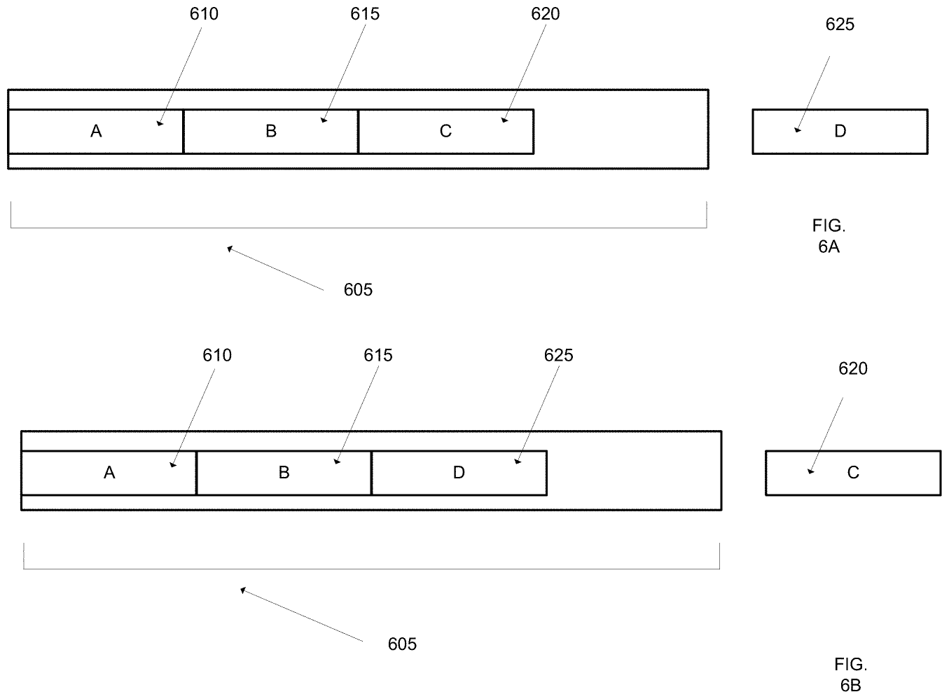

Specific to the system, method and tangible computer readable medium of the present disclosure, the transaction analysis system 110 may take in fraud data 122A from a variety of sources such as the fraud module 152 from the merchant computer system 106 and from other sources including the parties that assist in the transaction, store the fraud data 122A in a fraud database 122 or one or more of the various databases 124 and may analyze the fraud data 122A to quickly and efficiently provide a fraud score 123 to users. The operation and application of machine learning as part of the transaction analysis system 110 may be further described in relation to FIGS. 5, 6a and 6b.

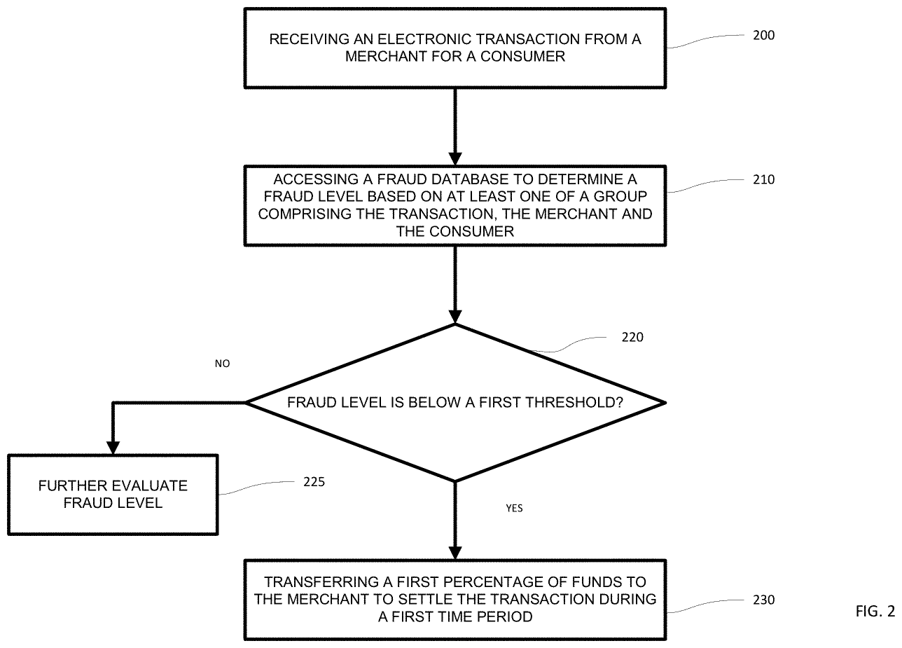

FIG. 2 may illustrate a sample method that may physically configure a processor as part of the system. As mentioned previously, at a high level, merchants often have to wait a period of time to receive funds for their transactions. For transactions that are not problematic, it may be helpful for merchants to have funds sooner. However, the traditional four party model adds delays to reduce risk to the parties to the transaction. There are many technical problems to speed up the transactions and the disbursements of funds to merchants. To address these technical problems, the transaction may be compared in almost real time to a fraud database 122. Based on the fraud score 123 which may be determined in virtually real time by communicating the transaction data to a fraud rating API which may be in communication with a fraud database 122, a percentage of the transaction may be made immediately be available to a merchants.

FIG. 2 may describe a sample method of adjusting an electronic payment clearance. At block 200, an electronic transaction may be received from a merchant for a consumer. The transaction may be any transaction for a good or service. The electronic payment may be a traditional credit or debit card or may be an electronic transaction using an electronic wallet. In addition, the system is contemplated to operate with other electronic payment systems such as frequent flyer points, reward points, electronic currency exchanges such as Bitcoin or Etherium or any other account which has value that may be transferred including systems that use blockchain to assist in executing the transaction.

The transaction may include a variety of information depending on the currency and the electronic payment system. In some embodiments, the transaction may include an amount of the transaction. Additional information may also be included such as an identifier of the payor, and an identifier of the payee. The identifier may take on many forms such as an account number of a payee, an account number of a payor or other information that may indicate the source and destination of the funds. In some embodiments, the transaction data may include information on the location of the merchant, the time of the transaction or whether the transaction occurred with a physical payment device like a credit card being present or if the purchase was completed with the payment device not being present. Logically, in some embodiments, there also may be a description of the good or service which was purchased. Additionally, in some embodiments, some or all of the data may be encrypted or otherwise secured for additional security.

At block 210, a fraud database 122 may be accessed to determine a fraud level. The fraud database 122 may take into account a variety of factors to create a fraud level such as the store location, the amount, the time of the transaction, the merchant and the buyer. The fraud database 122 may be created and stored by a variety of players in the payment system. For example, an issuer of a credit card may have a fraud database. Similarly, an acquirer may have a fraud database. Some merchants may have a fraud database. And outside services may also have fraud databases. All such databases are contemplated as being possibly used by the system, either alone, in combination or as in part of a large database created specifically for this system.

To be part of the system, the fraud database 122 may have some useful properties. One useful property may be that the system responds quickly when queried for a fraud score. In one embodiment, the system may use a fraud API to increase speed and reliability of the system. For example, the fraud API may expect certain information such as the purchaser and amount to be communicated in certain fields and the API may promptly respond with a fraud score. The fraud score 123 response or input may also follow a protocol such that the receiver may easily and efficiently understand the response.

Another property may be that the fraud database 122 may be conservative with a fraud score, especially when the level of information used to respond is not deep. For example, a new user a credit card may not have much purchase history such that the fraud database 122 does not have much information to use to create a fraud determination. Thus, the fraud score 123 may be higher than expected as one of the goals of the system may be to pay a merchant when the risk is low but may be to follow a more traditional system when the level of fraud knowledge is not deep or lacks confidence.

In addition, the fraud algorithm may use machine learning to analyze several fraud databases to improve the instant score over time. Some fraud databases may prove to be better over time than other fraud databases. Similarly, in the situation where there are a plurality of databases, some databases may be given a greater weight than other database. In addition, the various fraud algorithms may be combined into a single fraud database 122 which may be able to respond more quickly than checking a plurality of fraud databases.

In some embodiments, the fraud score 123 may be a number. The number may be a representation of the likelihood of the transaction being fraudulent or having one party in the transaction not honor the transaction. A scale may be used to represent the risk of the transaction. For example, the scale may be from 0-100 where a 100 score may indicate that fraud is virtually certain and a 0 may indicate that fraud is extremely unlikely. In other embodiments, the score may be a percentage where the percentage may indicate the likelihood of fraud. As an example, a 10% response may mean there is a 10% chance of fraud. In yet another embodiment, the response may be a letter. Of course, the fraud score 123 may take on a variety of formats such as one or more letters, one or more symbols, one or more numbers or a combination of all of these formats so long as everyone in the system understands what the score means. The use of a format or protocol may assist in eliminating any confusion over the fraud score.

At block 220, the it may be determined whether the fraud level is below a first threshold. In any transaction, there may be risk. Some parties in the transaction may be more tolerant of risk than other parties. For example, an account issuer that is anxious to build up a client base may be more willing to accept risk. In contrast, a high end account issuer may be less tolerant of risk. Thus, the parties to the transaction may be able to set the first threshold of the fraud score 123 as desired. The idea of the first threshold may allow the parties to the transaction to set the risk level at which they would immediately fund at least part of the transaction to the merchant.

Logically, there first threshold may have a variety of tiers. For example, the threshold may indicate that a score of 90/100 may be 100% funded immediately while of score of 80 may indicate that 50% of the transaction may be funded immediately and the second 50% may be funded in two days. The number and complexity of the tiers is virtually limitless.

If the fraud level is above the threshold, at block 225 the fraud level may be further evaluated. In some embodiments, the reason for the high fraud score may be identified and may be communicated to the parties in the transaction such that the reason may be identified and addressed. In some situations, a digit from an account may be missing or garbled and a simple re-entry may solve the problem. In other situations, a thief may be identified and authorities may be alerted.

At block 230, in response to the fraud level being below a first threshold, a first percentage of funds may be transferred to the merchant to settle the transaction during a first time period. As mentioned previously, the first threshold may indicate that a score of 90/100 may be 100% funded immediately while of score of 80 be under the first threshold but may be over a second threshold and may indicate that 50% of the transaction (a first percentage) may be funded immediately and the second 50% (a second percentage) may be funded in two days. There may be additional thresholds such as a third threshold and a third percentage. As an example, in response to the fraud level being below the third threshold but above the first threshold and the second threshold, the second percentage may be above 10%.

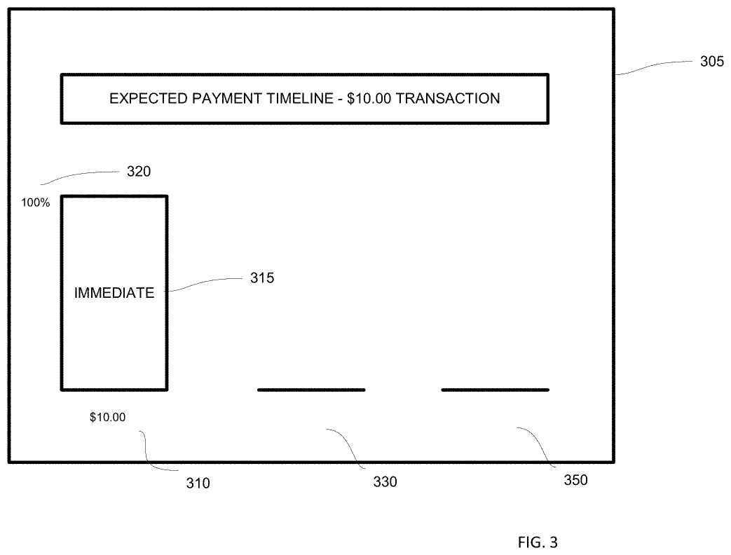

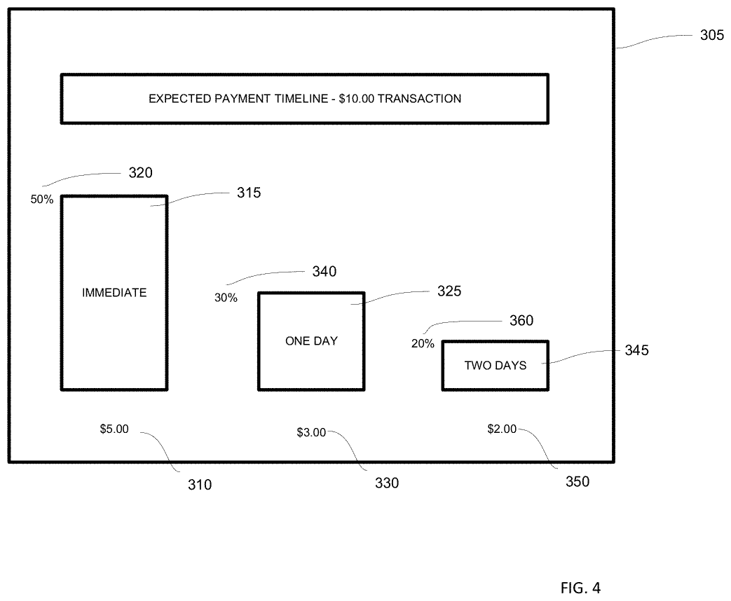

Referring to FIG. 3, in another aspect of the invention, a user interface 305 may display to the merchant the first amount 310, the first time 315 and the first percentage 320. Similarly, referring to FIG. 4, the user interface 305 may display to the merchant the second amount 330, the second time 325 and the second percentage 340. In some embodiments, a user interface 305 may display to the merchant the third amount 350, the third time 345 and the third percentage 360.

Machine learning may be used to assist in determining a fraud rating. Machine learning may be used to review a training group of past fraud rating data and determine fraud ratings moving forward. FIG. 5 may illustrate a sample artificial intelligence (AI) training data according to one or more embodiments. As an example and not a limitation, an artificial intelligence system may trained by analyzing a set of training data 605. The training data may be broken into sets, such as set A 610, set B 615, set C 620 and set D 625. As illustrated in FIG. 6a, one set may be using as a testing set (say set D 625) and the remaining sets may be used as training set (set A 610, set B 615 and set C 620). The artificial intelligence system may analyze the training set (set A 610, set B 615 and set C 620) and use the testing set (set D 625) to test the model create from the training data. Then the data sets may shift as illustrated in FIG. 6b, where the test data set may be added to the training data sets (say set A 610, set B 615 and set D 625) and one of the training data sets that have not been used to test before (say set C 620) may be used as the test data set. The analysis of the training data (set A 610, set B 615 and set D 625) may occur again with the new testing set (set C 620) being used to test the model and the model may be refined. The rotation of data sets may occur repeatedly until all the data sets have been used as the test data sets. The model then may be considered complete and the model may then be used on additional data sets.

In the specific case, past charges, disputes and fraudulent purchases may be may be analyzed regarding which situations where fraud ratings were previously determined for the purchases. Machine learning may be used to help identity which situations had the best fraud rating in comparison to the actual fraudulent purchases. Further additional steps may be identified from past experiences which may be useful in eliminating problems in the future. In addition, the machine learning may also be continually improved as data continues to flow into the model machine learning module which may be useful as the methods of fraud evolve and change over time.

In yet another embodiment, additional data may be used by the system to improve the results over time. While fraud may be one concern, there also may be other factors that are relevant to whether a merchant should be fully compensated immediately. For example, if a transaction is a direct electronic transfer from a funded account, the probability of the funding failing is very low. Thus, if the system is capable of determining that a transfer is fully funded, the merchant may be immediately compensated. Similarly, in certain situation, a transaction may be backed or insured by a third party making the risk of non-payment virtually zero. In such situations, the merchant may be fully funded immediately. Of course, additional factors and transaction type indicators may be used to assist in determining whether a merchant should be compensated in full virtually immediately or in percentages over time. Logically, machine learning may be useful in identifying the additional factors and whether weights may be useful with respect to the additional factors to assist in determining a preferred compensation schedule.

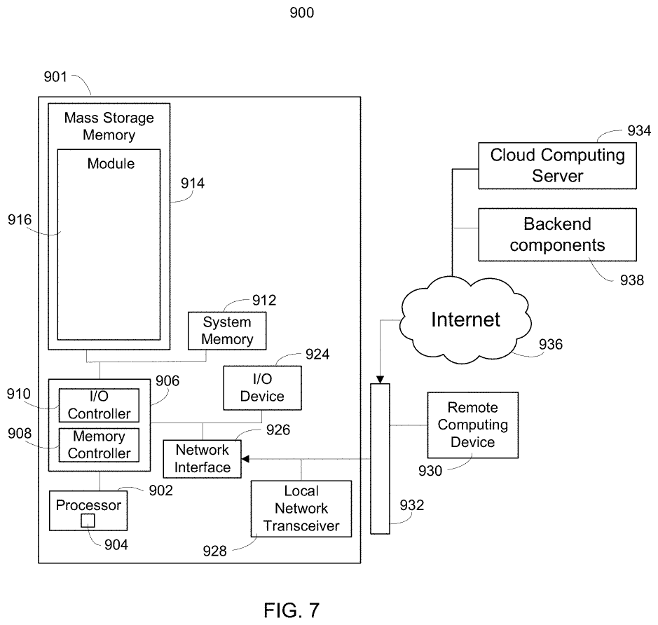

As illustrated in FIG. 1, many computers may be used by the system. FIG. 7 may illustrate a sample computing device 901. The computing device 901 includes a processor 902 that is coupled to an interconnection bus. The processor 902 includes a register set or register space 904, which is depicted in FIG. 7 as being entirely on-chip, but which could alternatively be located entirely or partially off-chip and directly coupled to the processor 902 via dedicated electrical connections and/or via the interconnection bus. The processor 902 may be any suitable processor, processing unit or microprocessor. Although not shown in FIG. 7, the computing device 901 may be a multi-processor device and, thus, may include one or more additional processors that are identical or similar to the processor 902 and that are communicatively coupled to the interconnection bus.

The processor 902 of FIG. 7 is coupled to a chipset 906, which includes a memory controller 908 and a peripheral input/output (I/O) controller 910. As is well known, a chipset typically provides I/O and memory management functions as well as a plurality of general purpose and/or special purpose registers, timers, etc. that are accessible or used by one or more processors coupled to the chipset 906. The memory controller 908 performs functions that enable the processor 902 (or processors if there are multiple processors) to access a system memory 912 and a mass storage memory 914, that may include either or both of an in-memory cache (e.g., a cache within the memory 912) or an on-disk cache (e.g., a cache within the mass storage memory 914).

The system memory 912 may include any desired type of volatile and/or non-volatile memory such as, for example, static random access memory (SRAM), dynamic random access memory (DRAM), flash memory, read-only memory (ROM), etc. The mass storage memory 914 may include any desired type of mass storage device. For example, the computing device 901 may be used to implement a module 916 (e.g., the various modules as herein described). The mass storage memory 914 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 901, the systems and methods described herein. Thus, a module, block, function, operation, procedure, routine, step, and method can be implemented in hardware, firmware, and/or software. In one embodiment, program modules and routines are stored in mass storage memory 914, loaded into system memory 912, and executed by a processor 902 or can be provided from computer program products that are stored in tangible computer-readable storage mediums (e.g. RAM, hard disk, optical/magnetic media, etc.).

The peripheral I/O controller 910 performs functions that enable the processor 902 to communicate with a peripheral input/output (I/O) device 924, a network interface 926, a local network transceiver 928, (via the network interface 926) via a peripheral I/O bus. The I/O device 924 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 924 may be used with the module 916, etc., to receive data from the transceiver 928, send the data to the components of the system 100, and perform any operations related to the methods as described herein. The local network transceiver 928 may include support for a Wi-Fi network, Bluetooth, Infrared, cellular, or other wireless data transmission protocols. In other embodiments, one element may simultaneously support each of the various wireless protocols employed by the computing device 901. For example, a software-defined radio may be able to support multiple protocols via downloadable instructions. In operation, the computing device 901 may be able to periodically poll for visible wireless network transmitters (both cellular and local network) on a periodic basis. Such polling may be possible even while normal wireless traffic is being supported on the computing device 901. The network interface 926 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 908 and the I/O controller 910 are depicted in FIG. 7 as separate functional blocks within the chipset 906, the functions performed by these blocks may be integrated within a single integrated circuit or may be implemented using two or more separate integrated circuits. The computing environment 900 may also implement the module 916 on a remote computing device 930. The remote computing device 930 may communicate with the computing device 901 over an Ethernet link 932. In some embodiments, the module 916 may be retrieved by the computing device 901 from a cloud computing server 934 via the Internet 936. When using the cloud computing server 934, the retrieved module 916 may be programmatically linked with the computing device 901. The module 916 may be a collection of various software platforms including artificial intelligence software and document creation software or may also be a Java® applet executing within a Java® Virtual Machine (JVM) environment resident in the computing device 901 or the remote computing device 930. The module 916 may also be a “plug-in” adapted to execute in a web-browser located on the computing devices 901 and 930. In some embodiments, the module 916 may communicate with back end components 938 via the Internet 936.

The system 900 may include but is not limited to any combination of a LAN, a MAN, a WAN, a mobile, a wired or wireless network, a private network, or a virtual private network. Moreover, while only one remote computing device 930 is illustrated in FIG. 6 to simplify and clarify the description, it is understood that any number of client computers are supported and can be in communication within the system 900.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method of adjusting an electronic payment clearance comprising:
receiving an electronic transaction from a merchant for a consumer;
accessing a fraud database to determine a fraud level based on at least one of a group comprising the transaction, the merchant and the consumer; and
in response to the fraud level being below a first threshold, transferring a first percentage of funds to the merchant to settle the transaction during a first time period.

2. The method of claim 1, wherein in response to the fraud level being below the first threshold, the first percentage is 100%.

3. The method of claim 1, wherein in response to the fraud level being below the first threshold, the first time period is virtually immediate.

4. The method of claim 1, further comprising
in response to the fraud level being below a second threshold, but above the first threshold,
transferring a second percentage of funds to the merchant during a second time period.

5. The method of claim 4, wherein in response to the fraud level being below the second threshold but the above first threshold, the second percentage of funds is above 50%.

6. The method of claim 4, wherein in response to the fraud level being below the second threshold but the above first threshold, the second time period is virtually immediate.

7. The method of claim 4, further comprising
in response to the fraud level being below a third threshold, but above the first threshold and the second threshold,
transferring a third percentage of funds to the merchant during a third time period.

8. The method of claim 7, wherein in response to the fraud level being below the third threshold but above the first threshold and the second threshold, the second percentage of funds is above 10%.

9. The method of claim 8, wherein in response to the fraud level being below the third threshold but above the first threshold and the second threshold, the third time period is virtually immediate.

10. The method of claim 1, wherein the fraud database is from a transaction account issuer.

11. The method of claim 1, wherein the fraud database is from a transaction clearance party.

12. The method of claim 1, wherein the fraud database is accessed using an application programming interface.

13. The method of claim 1, wherein the fraud database communicates using a protocol.

14. The method of claim 1, wherein a user interface displays to the merchant the a first amount, the first time and the first percentage.

15. The method of claim 4, wherein a user interface displays to the merchant a second amount, the second time and the second percentage.

16. The method of claim 7, wherein a user interface displays to the merchant a third amount, the third time and the third percentage.

17. The method of claim 1, wherein the transaction comprises an amount.

18. The method of claim 17, wherein the transaction comprises a good or service description.

19. The method of claim 17, wherein the transaction comprises a transaction time.

20. The method of claim 17, wherein the transaction comprises a merchant id or a merchant location.
